(19) United States
(12) Patent Application Publication
(10) Pub. No.: US 2007/0020076 A1
(43) Pub. Date: Jan. 25, 2007

(54) Cargo lifting apparatus for a vehicle

(75) Inventor: Robert Heynssens, Gladstone, MI (US)

Correspondence Address: QUARLES & BRADY LLP, 411 E. WISCONSIN AVENUE, SUITE 2040, MILWAUKEE, WI, 53202-4497, US

(73) Assignee: Power Platforms, Inc.

(21) Appl. No.: 11/178,563

(22) Filed: Jul. 11, 2005

(51) Int. Cl. B60P 1/00

(52) U.S. Cl. 414/541

(57) ABSTRACT

An apparatus for loading and unloading a vehicle with cargo includes tracks mounted to the vehicle and a plurality of hangers attached to travel along the tracks. A platform, for supporting the cargo, is suspended on ties from the hangers and has an elevator mechanism that winds and unwinds the ties on reels to raise and lower the platform. At least one stabilizer engages and inhibits the platform from swinging while being raised and lowered by the ties. Several moveable track assemblies also are disclosed.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to apparatus for loading and unloading a motor vehicle with cargo, and more particularly to such apparatus that is power operated and mounts on the motor vehicle, such as an over the highway truck, van or the like.

2. Description of the Related Art

An over the highway truck commonly has a body with an enclosed box into which cargo being hauled by the vehicle is placed. A door is provided, typically at the rear of the box, through which the cargo is loaded and unloaded. The floor of the box is approximately four feet above the ground, therefore many business have loading docks that are raised above the road surface to match the floor height of trucks.

However, many businesses at which cargo is infrequently loaded into large trucks and also residences do not have special loading docks. At these locations, the cargo must be raised into the truck box or lowered therefrom. An industrial lift truck can be utilized for that purpose, however an industrial truck is unavailable at many locations that do not have loading docks. Also after heavy cargo has been raised to the level of the truck floor, additional equipment may be needed to move the cargo inside the truck's box. Although ramps can be employed to transfer the cargo to and from the truck, they too are not always available at every delivery location. Therefore, it is desirable to provide a mechanism which is attached to the vehicle to load and unload cargo.

U.S. Pat. No. 6,666,643 discloses a load lifting apparatus that is used to load and unload objects from a truck. That apparatus includes a load carrying platform that is suspended by belts from tracks extending out the rear of the truck. The platform is raised and lowered by winding and unwinding the belts on and off reels in the platform. Although this apparatus operates satisfactorily, concern has been expressed that the platform may swing objectionably side to side or front and back while raising and lowering. Therefore, a mechanism to inhibit such swinging is desired.

Additional concern was expressed that in some locations the ground behind the truck was not level. In those situations, the front or back of the platform might not rest on the ground upon being lowered by the belts. Therefore, another mechanism to compensate for uneven or sloping ground also is desired.

### SUMMARY OF THE INVENTION

An apparatus for loading and unloading a vehicle with cargo includes a pair of tracks mounted to the vehicle in a spaced apart relationship. A plurality of hangers engage the tracks in a manner that allows each hanger to travel along the respective track. For example, the hangers have a plurality of wheels that ride in one or more grooves defined in the respective track. A platform has a frame for supporting the cargo and has an elevator mechanism. The elevator mechanism is mounted to the frame and is connected to the plurality of hangers for raising and lowering the platform with respect to the tracks. When the platform is suspended in air, the plurality of hangers can be pushed along the tracks which also moves the platform along the tracks into and out of the vehicle.

An aspect of the present invention provides at least one stabilizer that engages the platform and inhibits the platform from swinging while being raised and lowered. In one embodiment, the stabilizer is mounted on the vehicle in a manner that allows the stabilizer to move vertically. The stabilizer has a slot which receives a member on the platform when the platform is pulled out of the vehicle along the tracks. That member disengages the slot when the platform enters the vehicle.

Another aspect of the invention relates to manners in which the tracks are mounted to the vehicle. In one embodiment, the tracks can be slid along supports between a first position in which the tracks are stowed within the vehicle and a second position in which the tracks are cantilevered from the vehicle for raising and lowering the platform with respect to the ground adjacent the vehicle. Another embodiment enables the tracks to be tilted with respect to the vehicle which allows the platform to be placed onto uneven ground.

### BRIEF DESCRIPTION OF THE DRAWINGS

FIG. 1 is a fragmented perspective view of the rear of a truck on which a cargo lifting apparatus according to the present invention has been installed;

FIG. 2 is a longitudinal cross sectional view of the rear of the truck showing the cargo lifting apparatus;

FIG. 3 is a vertical cross sectional view through a first support for one of the tracks;

FIG. 4 is a fragmented vertical cross section through a second support for the track;

FIG. 5 is an enlarged fragmented view of the connection between two sections of a track of the cargo lifting apparatus;

FIG. 6 is a perspective view of a hanger which travels within the tracks of FIG. 3;

FIG. 7 is a top view of a platform of the cargo lifting apparatus, with a top plate removed;

FIG. 8 is a cross sectional view through a platform stabilizer taken along line 8-8 in FIG. 2;

FIG. 9 is a vertical cross sectional view through the platform stabilizer in a lowered position;

FIG. 10 is a vertical cross sectional view through the platform stabilizer in a raised position;

FIG. 11 is a cross sectional view of the rear of the truck with a track in a tilted position;

FIG. 12 is a cross sectional view of the rear of the truck showing an alternative mounting system for the tracks of the cargo lifting apparatus; and

FIG. 13 is a vertical cross sectional view through a support of the alternative track mounting system.

### DETAILED DESCRIPTION OF THE INVENTION

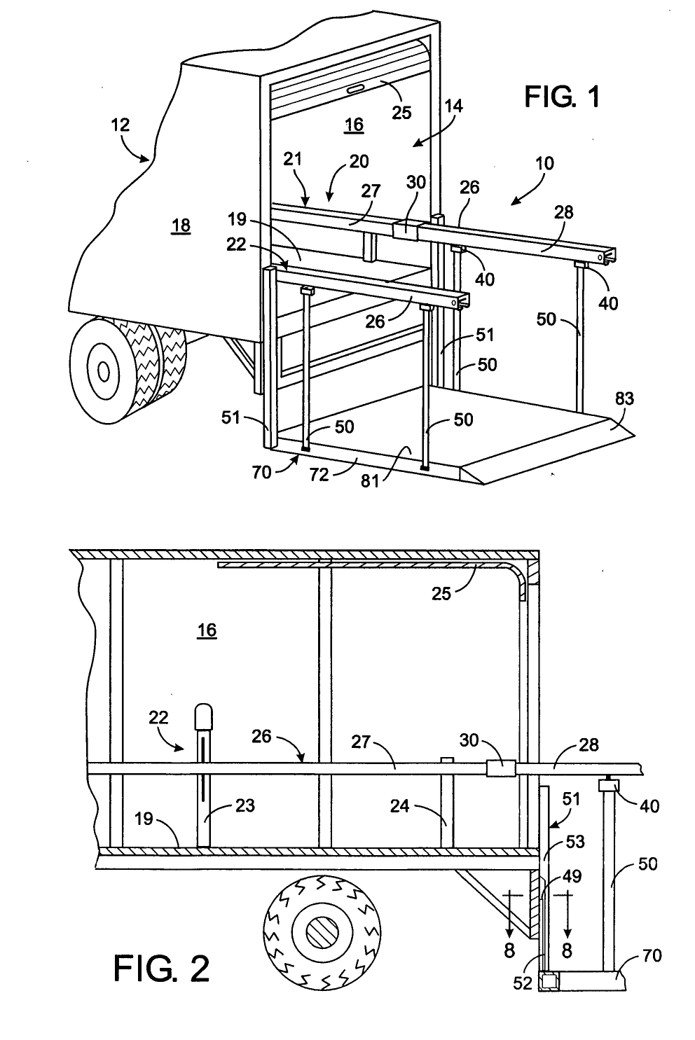

With initial reference to FIGS. 1 and 2, the present cargo lifting apparatus 10 is installed on a truck 12 for highway use which has a cargo box 14 defined by spaced apart side walls 16 and 18 with a floor 19 there between. Although the present invention is being described in the context of use on a truck, it can be employed with other types of motor vehicles and semi-trailers, generically referred to herein as a “vehicle”. A frame 20 of the cargo lifting apparatus 10 is mounted within the cargo box 14 being secured to the floor 19 and interior surfaces of side walls 16 and 18. The frame 20 includes a first track assembly 21 mounted adjacent the right wall 16 and a second track assembly 22 mounted adjacent the left wall 18. The two track assemblies 21 and 22 are mirror images of each other.

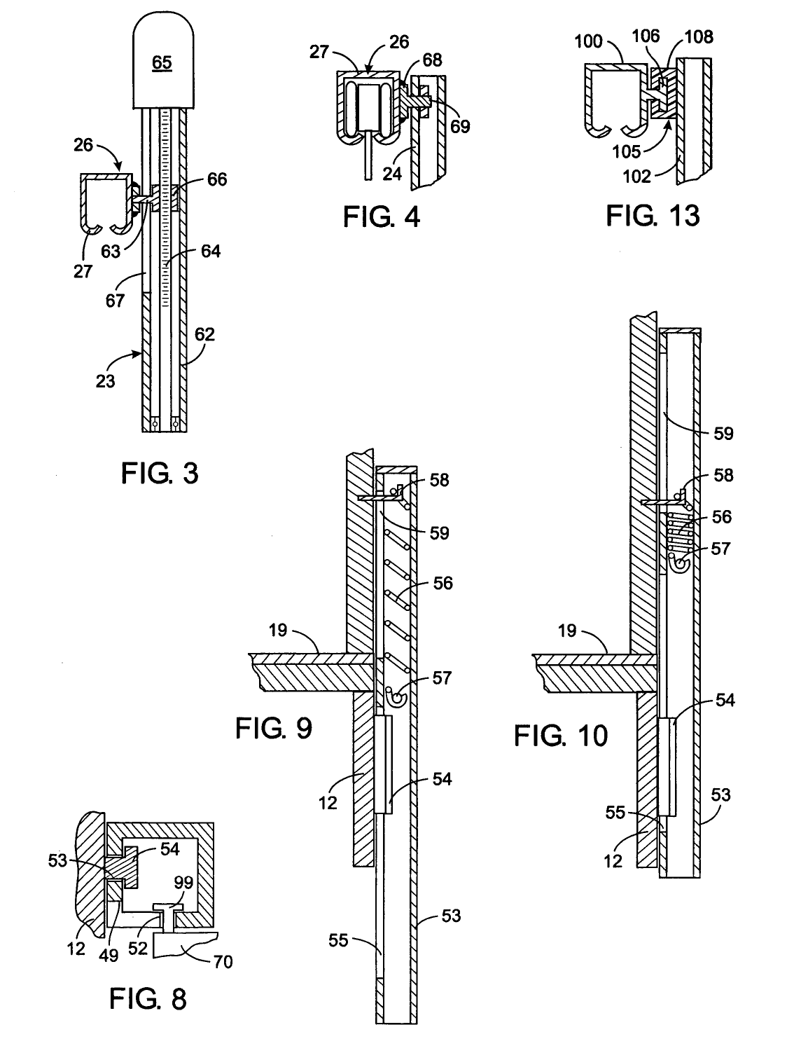

FIG. 2 illustrates the details of the first track assembly 21 that includes first and second vertical supports 23 and 24 that rest on the floor 19 and are attached by bolts, other fasteners or welds to the interior surface of the right wall 16 or to the floor. The vertical supports 23 and 24 carry a horizontally extending track 26 that has two sections 27 and 28. With additional reference to FIG. 3, the first vertical support 23 for the track is adjustable and has a post 62 formed by a square tube through which a threaded rod 64 extends. The upper end of the threaded rod 64 is connected to the shaft of a twelve volt, direct current, first electric motor 65 and the lower end is received in a bearing or bushing at the bottom end of the post 62. A traveler 66 is threaded onto the threaded rod 64 and has a rod 63 projecting through a slot 67 that extends longitudinally in the surface of the tubular post 62 that faces into the cargo box. The remote end of the rod 63 is pivotally connected to the first section 27 of the track 26.

The first electric motors 65 on both sides of the cargo box receive power from electrical system of the truck 12 which is controlled by a switch that determines the polarity and thus the direction that the motor operates. Activation of the first electric motor 65 rotates the threaded rod 64 within the post 62 which action moves the traveler 66 up or down depending upon the direction of that rotation. That motion of the traveler 66 in turn raises or lowers the first track section 27 with respect to the floor 19 of the cargo box 14. Alternatively, the first and second vertical supports 23 and 24 can be reversed so that the adjustable one is toward the rear of the over the highway truck 12. As a further alternative, both of the vertical supports 23 and 24 on each side of the truck can be adjustable.

With reference to FIG. 4 the first section 27 of the track 26 also is pivotally connected to the second track support 24. Specifically, a bracket 68 is attached to the first track section 27 and has a pivot rod 69 that extends through an aperture in the second track support 24 in a manner that allows that rod to rotate in the aperture.

Returning to FIG. 2, the track 26 has a first section 27 running the length of the cargo box 14 from front to back and attached to the first and second vertical supports 23 and 24. The track has a second section 28 removably connected by a coupling 30 to the rear end of the first track section 27. The second section 28 projects out of the back of the cargo box 14 in a cantilevered fashion. The second track section 28 can be removed from the coupling 30 and stored within the truck 12 between loading and unloading operations, such as when the truck is traveling over the roads. That removal allows the sliding overhead style rear door 25 of the truck to close the opening into the cargo box.

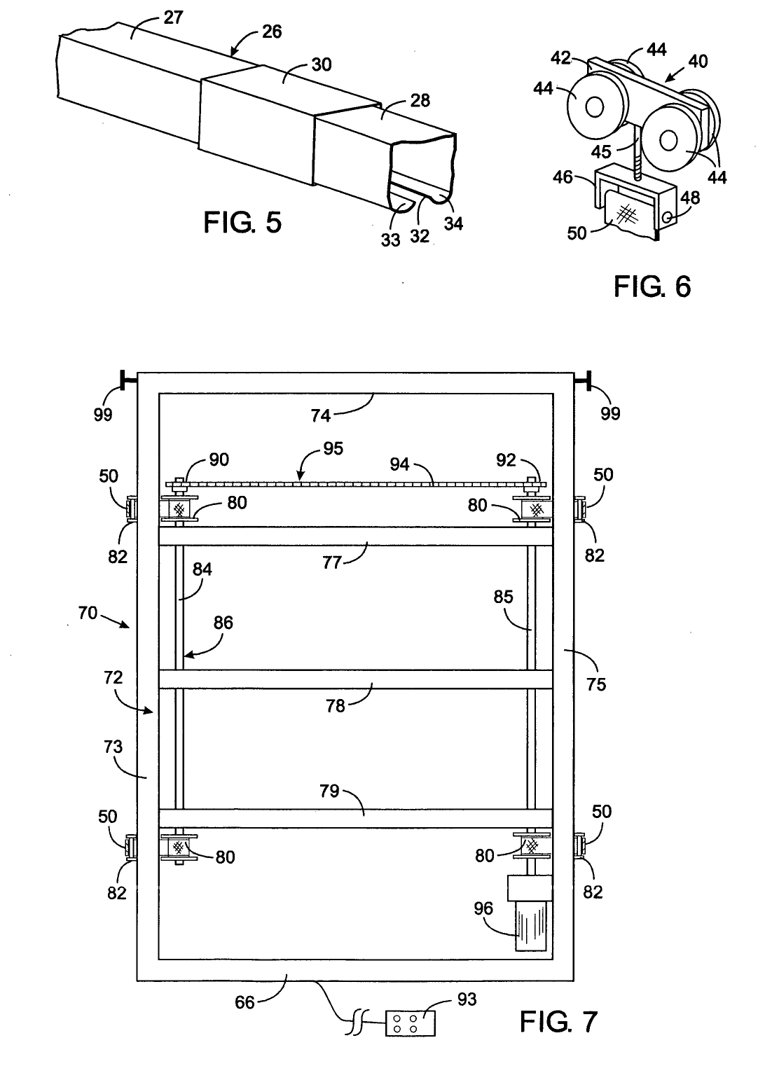

With reference to FIG. 5, the two sections 27 and 28 of track 26 are similar to tracks used to support sliding doors, being formed from a square or rectangular cross section tube with a central longitudinal slot 32 in the bottom side as illustrated for the second section 28. The longitudinal slot 32 is defined in the tracks by two internally curved bottom walls 33 and 34, that form a pair of grooves. The bottom side of the coupling 30 has an identical configuration, thereby securing engaging the two track sections to support the second section 28 that is cantilevered from the truck.

A pair of wheeled hangers 40, shown in FIG. 6, ride within the track 26 of each track assembly 21 and 22. Each wheeled hanger 40 comprises a bar 42 to which four wheels 44 are attached by a pair of axles extending through apertures in the bar. The wheels and bar are received within the tracks 26 in FIG. 5 with the wheels riding in the grooves formed by the curved bottom walls 33 and 34. A threaded rod 45 extends downwardly from the bar 42, passing through the slot 32 in the tracks 26. An inverted U-shaped bracket 46 is attached to the lower end of the threaded rod 45 and has a pin 48 extending between its downwardly projecting legs. The pin 48 passes through a loop at one end of a tie, such as a woven fabric belt 50. Any of several kinds of flexible ties may be substituted for the woven fabric belt 50. For example, a rope, cable, wire rope, chain, other type of a belt, and the like may be used and are generically referred to herein as a “tie” or collectively as “ties.”

Referring again to FIG. 1, the fabric belts 50 extend down from each of the wheeled hangers 40 to a cargo platform 70 that is shown in detail in FIG. 7. As will be described, the suspension of the cargo platform 70 on the fabric belts 50 allows the platform, when raised sufficiently above the ground, to travel along the track 26 into and out of the cargo box 14 of the over the highway truck 12. Therefore, the cargo platform 70 is sized to fit through the rear doorway of the truck 12.

The cargo platform 70 has a rectangular frame 72 with a flat metal plate 81 thereon that provide s a surface on which to place the objects being lifted to and from the truck 12. A ramp 83 can be included to aid in moving the objects on and off the platform. With reference to FIG. 7, the platform frame 72 is formed by four metal outer members 73, 74, 75, and 76, which are welded together. Three metal transverse members 77, 78 and 79 extend within the frame between outer members 73 and 75 to provide additional support for the load being carried.

Four pulleys 82 are attached to the outside vertical surfaces of the outer frame members 73 or 75 with the belts 50 passing over the pulleys and through an aperture in the adjacent outer frame member. Each belt 50 then winds onto one of four reels 80 within the frame 72. The two reels 80 that are adjacent outer member 73 are fixedly attached to a first shaft 84 which is parallel to that frame member, The first shaft 84 extends through apertures in the transverse frame members 77, 78 and 79 and is supported therein by bearings (not visible). Similarly, the other two reels 80 adjacent the opposite outer member 75 are fixedly attached to a second shaft 85 extending parallel to that member. The second shaft 85 also extends through apertures in the transverse frame members 77, 78 and 79 being supported by bearings. A pair of sprockets 90 and 92 are respectively attached to ends of the two shafts 84 and 85 and a chain 94 is connected between those sprockets to form a mechanical linkage 95 that rotationally couples the two shafts. Other kinds of mechanical linkages, such as a transverse shaft and bevel gears, can be used in place of the sprockets and chain to couple the two shafts. The two shafts 84 and 85 and the mechanical linkage 95 comprise a transmission 86 for rotating the four reels 80.

A second electric motor 96 is coupled to the opposite end of one shaft 85 and the polarity of the direct current applied to that electric motor 96 determines the direction in which the shafts 84 and 85 rotate. One polarity is used to wind the belts 50 onto the reels 80 and the opposite polarity is employed to unwind the belts. The electrical system of the truck 12 provides power for the second electric motor 96 in response to operation of a hand-held control unit 93 by which enables the user to activate the motor and select the direction of rotation. Alternatively another type of a prime mover, such as a hydraulic motor or an internal combustion engine, can be substituted for the second electric motor 96. The transmission 86 and the second electric motor 96 form a drive for rotating the reels 80.

Rotation of the first and second shafts 84 and 85 in one direction causes the woven fabric belts 50 to wind onto the four reels 80. The belts 50 on one side of the frame 72 are wound in the opposite direction around the reels 80 from the belts on the other side of the frame so that the rotation of the shafts 84 and 85 in one direction winds all the belts onto the reels. This action raises the cargo platform 70 toward the tracks 26. Rotation of the shafts 84 and 85 in the opposite direction unwinds the belts 50 from the reels 80 and lowers the cargo platform 70.

The cargo platform 70 has a pin 99 with a large head projecting outward near the front end of each side. Referring to FIGS. 1 and 8, each pin 99 engages a separate stabilizer 51 on opposite sides of the door 25 at the rear of the truck 12 when the cargo platform 70 is pulled out of the truck along the tracks 26. Each stabilizer 51 has a square tubular body 53 with a first slot 52 extending longitudinally in the lower half of the inside facing surface. The upper end of that first slot 52 has a wide opening 49 through the forward surface of the tubular stabilizer body 53. That opening 49 of the first slot 52 is designed to receive the pin 99 on the adjacent side of the cargo platform 70. Engagement of the platform pins 99 with the stabilizers 51 inhibits the cargo platform from swinging as it is raised and lowered on the flexible belts 50. The pins 99 disengage from the stabilizers 51 when the cargo platform 70 is pushed into the cargo box 14.

With particular reference to FIGS. 8-10, the stabilizer 51 is attached to the rear frame of the truck 12 in a manner that allows the stabilizer to slide up and down as the cargo platform 70 is raised and lowered. Specifically, the stabilizer 51 has a second longitudinal slot 55 in the lower portion of its front surface through which a T-shaped bar 54 extends from the truck frame. Thus the stabilizer 51 can slide up and down against the rear of the truck, while being held against the truck by the T-shaped bar 54. A third slot 59 is located in the upper portion of the front surface of the stabilizer body 53 and a hook 58 mounted on the truck 12 projects through that latter slot. Alternatively, a be stabilizer body 53 may be used in which case the hook 58 projects through slot 55. A spring 56, inside the stabilizer body 53, has an upper end looped around the hook 58 and has a lower end engaging a post 57 in the stabilizer body. When the cargo platform 70 is on the ground behind the truck, its engagement with the stabilizer 51 pulls the stabilizer body 53 downward which stretches the spring 56 as depicted in FIG. 9. When the cargo platform 70 is stowed in the truck, the spring 56 is contracted, which draws the post toward the hook 58 as shown in FIG. 10, thereby raising the stabilizer 51. In the raised state, the opening of the first slot 52 in the stabilizer 51 is slightly above the truck floor 19, approximately at the level of the pins 99 on the cargo platform 70. Other types of biasing devices, such as a counterbalance weight, can be used in place of the spring to raise the stabilizer 51.

To remove the stowed cargo platform 70 from the truck, the second motor 96 is energized to wind the belts 50 farther onto the reels 80 and raise the platform a small distance above the truck floor 19. Then the cargo platform 70 is pulled out of the truck 12 along the tracks 26. As that occurs, the pins 99 projecting from each side of the cargo platform enter the openings 49 of the first slots 52 in the stabilizers 51. That entrance limits how far backward the cargo platform 70 may be pulled from the cargo box 14. Then, the electric motor 96 is energized to unwind the belts 50 from the reels 80 and lower the cargo platform 70 toward the ground. As the platform lowers, the pins 99 slide within the first slots 52 of the stabilizers until reaching the bottoms of those slots. Continued lowering of the cargo platform 70 now pulls the stabilizers 51 downward along the T-shaped bars 54. The retention of the pins 99 in the first slots 52 of the stabilizers 51 inhibits the cargo platform 70 from swinging side to side and front to back as it lowers to the ground. Such swinging also is inhibited as the cargo platform 70 is raised from the ground, during which time contraction of the spring 56 also raises the stabilizer body 53. Thus each pin 99 forms a member that engages both the platform and one of the stabilizers 51 while the platform is being raised or lowered to inhibit the swinging. Each pin 99 allows the cargo platform 70 to pivot in the stabilizers 51, thereby enabling the angle of the platform 70 to conform to the ground.

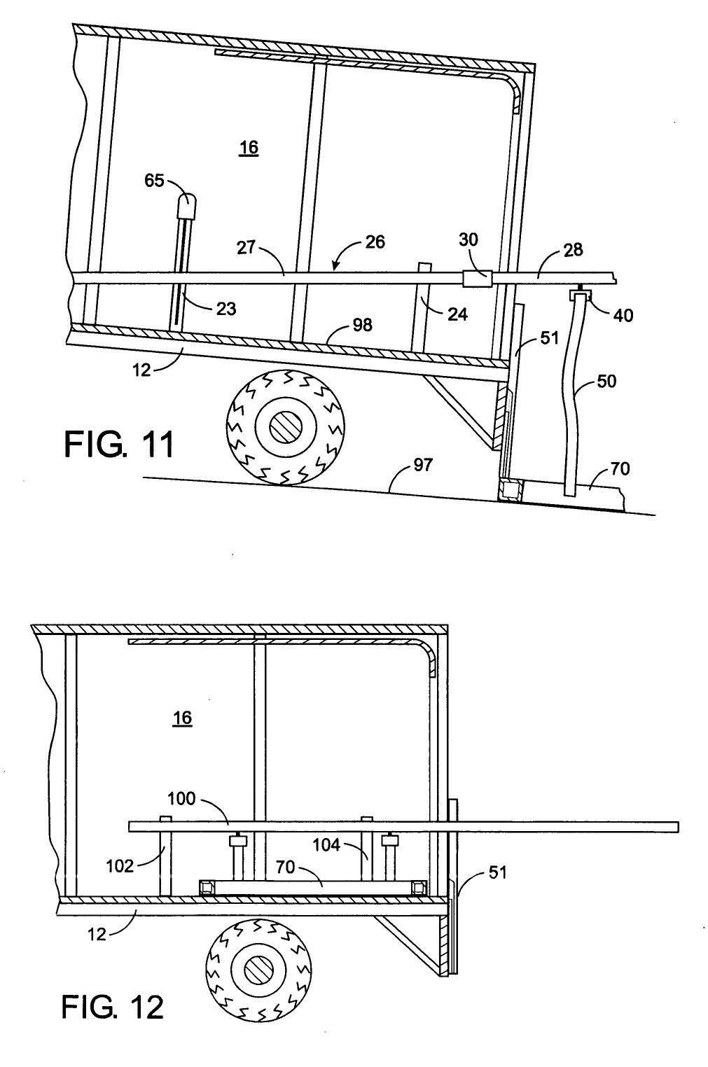

FIGS. 1 and 2 depict the cargo lifting apparatus 10 positioned to receive objects for loading on the truck 12 that has been stopped on level ground. However, the ground 97 beneath the truck is not always level or flat as illustrated in FIG. 11. In those situations, the tracks 26 can be tilted to maintain the cargo platform 70 horizontal as it is lowered and raised. Assume that the truck 12 stops facing upward on a hill, at which time the cargo platform 70 is resting on the floor 98 within the cargo box 14. The driver the extends the tracks 26 out the rear doorway. The first support 23 for the track 26 then is operated to lower the front portion of the first track section 27 which pivots about the second track support 24, thereby tilting the second section 28 upward into a generally horizontal orientation. The second section 28 may be tilted slightly downward so that gravity will aid in sliding the cargo platform 70 out of the truck. Next, the cargo platform 70 is raised off the floor 98 and is slid along the tracks 26 out of the cargo box 14 in the same manner described previously. Thereafter, the cargo platform 70 is lowered until the forward end strikes the ground 97 after which continued lowering drops the rear end of the cargo platform so that the entire platform rests solidly on the ground that slopes downward away from the rear of the truck 12. If truck is parked facing down a hill, raising the first vertical support 23 tilts the rear end of the track 26 downward into a horizontal position.

The track assemblies 21 and 22 comprise two separate sections 27 and 28 that are removably connected together by the coupling 30 to form the track that is cantilevered from the rear of the truck 12. The second section 28 must be detached and stored in the truck in order to move the truck on a road. Alternatively as shown in FIG. 12, a single piece track 100, that slides into and out of the cargo box 14, can be employed. The track 100 is connected to the two vertical supports 102 and 104 by coupling 105 that allows the track to slide horizontally. Such a coupling 105 is illustrated in FIG. 13 in which a T-shaped element 106 extends along one side of the full length of the track 100. The T-shaped element may be an integral part of the extrusion of the track or a separate element attached thereto. The cross member of the T-shaped element 106 slides within a mating slot in a bracket 108 attached to the forward vertical support 102. The track 100 is no longer than the length of the cargo box 14 so that it may be retracted therein. When loading or unloading is to occur the tracks are slid out of the cargo box as depicted in the drawing. Note that FIG. 12 shows the cargo platform stowed within the truck 12 and the stabilizer 51 in the raised position.

The embodiment shown in FIG. 12 does not enable the track 100 to tilt unlike the tracks in FIG. 11. If tilting is desired, a motorized support, like the first support 23, can be used as the forward support 102, in which case the sliding couplings 105 of both vertical supports must also allow pivoting.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

What is claimed is:

1. An apparatus for loading and unloading a vehicle with cargo, said apparatus comprising:
a pair of tracks mounted on the vehicle in a spaced apart relationship;
a plurality of hangers each engaging one of the tracks and capable of traveling there along;
a platform having a frame for supporting the cargo, and having an elevator mechanism mounted to the frame and connected to the plurality of hangers for raising and lowering the platform with respect to the tracks; and
at least one stabilizer engaging the platform and inhibiting the platform from swinging while raising and lowering.

2. The apparatus recited in claim 1 wherein the elevator mechanism comprises:
a plurality of reels;
a plurality of ties each connected to one of the plurality of hangers and wound onto one of the plurality of reels; and
a driver for rotating the plurality of reels to wind and unwind the plurality of ties thereon.

3. The apparatus as recited in claim 1 wherein the stabilizer has a slot; and the platform has a member projecting from the frame and slideably engaging the slot while the platform is raised and lowered.

4. The apparatus as recited in claim 1 wherein the platform disengages from the stabilizer upon the plurality of hangers traveling along the tracks.

5. The apparatus as recited in claim 1 wherein the stabilizer is attached to the vehicle and moves vertically with respect to the vehicle in response to the platform being raised and lowered.

6. The apparatus as recited in claim 1 wherein the stabilizer is movably attached to the vehicle and includes a biasing device that exerts a force that tends to move the stabilizer upward with respect to the vehicle.

7. The apparatus as recited in claim 1 wherein the pair of tracks are extendable from the vehicle.

8. The apparatus as recited in claim 1 wherein the pair of tracks are slideably mounted so as to be retractable into and extendable from the vehicle.

9. The apparatus as recited in claim 1 further comprising a first support and a second support provided for each track, wherein the first support is attached to the vehicle and to the respective track and has a device for raising and lowering the respective track, and wherein the second support is attached to the vehicle and to the respective track.

10. The apparatus as recited in claim 9 wherein the second support is pivotally attached to the respective track.

11. An apparatus for loading and unloading a vehicle with cargo, said apparatus comprising:
a pair of tracks mounted on the vehicle in a spaced apart relationship; wherein each track entirely being moveable with respect to the vehicle;
a plurality of hangers, each engaging one of the tracks and capable of traveling along that one of the tracks; and
a platform having a frame for supporting the cargo, and having an elevator mechanism mounted on the frame and having a plurality of ties connected to the plurality of hangers for raising and lowering the platform with respect to the tracks.

12. The apparatus as recited in claim 11 wherein each track is slideably mounted to the vehicle and is retractable into and extendable from the vehicle.

13. The apparatus as recited in claim 111 wherein each of the pair of tracks is mounted in a tiltable manner to the vehicle.

14. The apparatus as recited in claim 111 further comprising, for each of the pair of tracks a separate set of a first support and a second support, wherein the first support has a device for raising and lowering the respective track, and wherein the second support is pivotally attached to the respective track.

15. The apparatus as recited in claim 11 further comprising at least one stabilizer engaging the platform and inhibiting the platform from swinging during raising and lowering.

16. The apparatus as recited in claim 15 wherein the stabilizer has a vertical slot; and the platform has a member projecting from the frame and slideably engaging the vertical slot while the platform is raised and lowered.

17. The apparatus as recited in claim 16 wherein the member disengages from the slot upon the plurality of hangers traveling along the tracks.

18. The apparatus as recited in claim 15 wherein the stabilizer is attached to the vehicle and moves vertically with respect to the vehicle in response to the platform being raised and lowered.

19. The apparatus as recited in claim 18 wherein the stabilizer comprises a biasing device which exerts a force that tends to move the stabilizer upward with respect to the vehicle.

20. An apparatus for loading and unloading a vehicle with cargo, said apparatus comprising:
a pair of tracks mounted to the vehicle in a spaced apart relationship;
a plurality of hangers each one engaging one of the tracks and capable of traveling along that one of the tracks;
a platform having a frame for supporting the cargo, and having an elevator mechanism mounted on the frame and having a plurality of ties connected to the plurality of hangers for raising and lowering the platform with respect to the tracks; and
a stabilizer attached to the vehicle; and
a member which engages the platform and the stabilizer thereby inhibiting the platform from swinging while raising and lowering.

21. The apparatus as recited in claim 20 wherein the stabilizer has a vertical slot; and the member projects from the platform and slideably engages the vertical slot while the platform is raised and lowered.

22. The apparatus as recited in claim 21 wherein the member disengages from the slot upon the platform being raised to a given height and the plurality of hangers moving along the tracks.

23. The apparatus as recited in claim 20 wherein the stabilizer is attached to the vehicle and moves vertically with respect to the vehicle in response to the platform being raised and lowered.

24. The apparatus as recited in claim 23 wherein the stabilizer comprises a biasing device which exerts a force that tends to move the stabilizer upward with respect to the vehicle.
